(19) United States
(12) Patent Application Publication
(10) Pub. No.: US 2010/0246697 A1
(43) Pub. Date: Sep. 30, 2010

(54) Apparatus, Method and Computer Program Product Providing Feedback for Closed-Loop Wideband MIMO-OFDM System

(75) Inventors: Yong Teng, Beijing (CN); Olav Emerik Tirkkonen, Helsinki (FI)

Correspondence Address: Nokia, Inc., 6021 Connection Drive, MS 2-5-520, Irving, TX, 75039, US

(73) Assignee: NOKIA CORPORATION, Espoo (FI)

(21) Appl. No.: 12/443,468

(22) PCT Filed: Sep. 21, 2007
(86) PCT No.: PCT/IB07/02757

§ 371 Date: May 14, 2010

(30) Foreign Application Priority Data
Sep. 28, 2006 (US) 60848330

(51) Int. Cl. H04L 27/28

(52) U.S. Cl. 375/260

(57) ABSTRACT

In one exemplary aspect thereof the embodiments of this invention provide an apparatus that includes a wireless receiver configurable to receive resource units; a wireless transmitter configurable to transmit feedback information to a source of the received resource units; and a channel estimator and feedback generator coupled to the wireless receiver and to the wireless transmitter. The channel estimator and feedback generator is configurable to determine a weight for each of a first resource unit and a second resource unit that are received by the receiver spaced apart at least in frequency, to determine a weight for at least some of a plurality of resource units that are intermediate at least in frequency to the first and the second resource units, and to send feedback via the transmitter. The feedback includes an indication of the determined weight for the first and the second resource units using X bits for representing each of the indications of the determined weights, and further includes an indication of weights for each of the plurality of resource units using Y bits, where Y<X. The indication of the weights for each of the plurality of resource units specifies for use the transmitted indication of the determined weight of either the first resource unit or the second resource unit. The apparatus may be embodied in a user equipment operable in aMEVIO-type wireless communication system.

### TECHNICAL FIELD

The exemplary and non-limiting embodiments of this invention relate generally to wireless communication systems, methods, apparatus, devices and computer program products and, more specifically, relate to those types of systems known as multi-input, multiple-output (MIMO) systems having multiple antennas.

### BACKGROUND

The following abbreviations are herewith defined:

BS base station (referred to as a Node B in LTE)
CSI channel state information
CSIT channel state information at transmitter
DL downlink
FB feedback
FDD frequency division duplex
FP full precision
LTE long term evolution
LRB left resource block
LW left weight
OFDM orthogonal frequency division multiplexing
RB resource block
RRB right resource block
RW right weight
SNR signal to noise ratio
UE user equipment
UL uplink
UTRA universal terrestrial radio access

The performance of a multiple antenna system can be improved by exploiting CSI at the transmitter. Transmit beamforming or precoding is one potential method with CSIT, which has been used in WCDMA, and which is also quite promising in the UTRA LTE system. Since CSIT should be available for precoding schemes, an efficient feedback method is necessary in FDD mode. When OFDM is used for a wideband system (e.g., a 10 MHz bandwidth system), the feedback overhead for short term beamforming or precoding can be quite large, in particular if the feedback is provided in a frequency selective manner.

As an example, in the LTE DL, the general assumption is that the active sub-carriers (tentatively 600 active sub-carriers in a 10 MHz bandwidth) are divided into a number of RBs. For example, there may be 24 RBs each having 25 sub-carriers in the 10 MHz system. The general assumption is that for precoding (or short-term beamforming), one RB is the minimum unit that precoding weight information would be fed back for.

As was noted, in such a wideband system, especially in a wideband OFDM system, the feedback overhead for use in short term beamforming or precoding is large. This can be especially true if the feedback is provided in a manner that the fed back precoding weight is used in an attempt to track variations in an optimum feedback weight in the frequency domain. For example, if three bits are fed back for each RB, the total amount of required feedback for determining the precoding over the entire 10 MHz bandwidth is 72 bits (3 bits*24 RBs).

As can be appreciated, one possible method to reduce the feedback overhead is group-based feedback, in which several RBs are grouped together and one weight is used for all RBs in one group. However, use of this approach would incur a loss in performance.

Another method is using a weight which is within some distance in a codebook to a weight with full precision. However, this approach adds computational complexity, as it needs to calculate the distances between various weights in the codebook. Moreover, the process is closely linked to the structure of the codebook. This would mean that there is a codebook used for higher precision feedback that is used for a number of RBs, and for intermediate RBs a smaller “tracking” codebook is used. The use of the tracking codebook indicates the possibility to move to a number of neighboring weights of the present weight. Reference can be had to an article entitled: “Recursive and Trellis-based Feedback Reduction for MIMO-OFDM and Transmit Beamforming”, Shengli Zhou, Baosheng Li and Peter Willett, IEEE Globecom'2005, vol. 6, pp. 3912-3916, November 2005.

Another method is feeding back nothing for intermediate RBs between two RBs with full precision feedback. At the transmitter interpolation is used to determine a weight for the intermediate RBs based on the weights of the full precision RBs. While this approach does reduce the feedback overhead, it also suffers from a loss of performance. Reference can be had to an article entitled: “Interpolation Based Transmit Beamforming for MIMO-OFDM with Limited Feedback”, J. Choi and R. W. Heath, Jr., IEEE ICC'2004, vol. 1, pp. 249-253, June 2004.

### SUMMARY

The foregoing and other problems are overcome, and other advantages are realized, in accordance with the non-limiting and exemplary embodiments of this invention.

In a first aspect thereof the exemplary embodiments of this invention provide a method that includes determining a weight for each of a first resource unit and a second resource unit that are spaced apart at least in frequency; determining a weight for at least some of a plurality of resource units that are intermediate at least in frequency to the first and the second resource units; and transmitting an indication of the determined weight for the first and the second resource units using Xbits for representing each of the indications of the determined weights, and also transmitting an indication of weights for each of the plurality of resource units using Y bits, where Y<X, and where the indication of the weights for each of the plurality of resource units specifies for use the transmitted indication of the determined weight of either the first resource unit or the second resource unit.

In a second aspect thereof the exemplary embodiments of this invention provide an apparatus that includes a wireless receiver configurable to receive resource units; a wireless transmitter configurable to transmit feedback information to a source of the received resource units; and a channel estimator and feedback generator coupled to the wireless receiver and to the wireless transmitter. The channel estimator and feedback generator is configurable to determine a weight for each of a first resource unit and a second resource unit that are received by the receiver spaced apart at least in frequency, to determine a weight for at least some of a plurality of resource units that are intermediate at least in frequency to the first and the second resource units, and to send feedback via the transmitter. The feedback comprises an indication of the determined weight for the first and the second resource units using Xbits for representing each of the indications of the determined weights, and further comprises an indication of weights for each of the plurality of resource units using Y bits, where Y<X The indication of the weights for each of the plurality of resource units specifies for use the transmitted indication of the determined weight of either the first resource unit or the second resource unit.

In another aspect thereof the exemplary embodiments of this invention provide a method that includes transmitting a plurality of resource units; receiving resource unit-related feedback information comprised of first indications, each specified with X bits, of a determined weight for a first resource unit and an indication of a determined weight for a second resource unit, the first and second resource units being spaced apart at least in frequency; the feedback information further comprising at least one second indication, specified with Y bits where Y<X, of weights for each of a plurality of resource units intermediate the first and second resource units; and determining a weight for each of the plurality of intermediate resource units, where the at least one second indication specifies for use the indication of the determined weight of either the first resource unit or the second resource unit.

In a further aspect thereof the exemplary embodiments of this invention provide an apparatus that includes a wireless transmitter configured to transmit a plurality of resource units and a wireless receiver configured to receive resource unit-related feedback information comprised of first indications, each specified with X bits, of a determined weight for a first resource unit and an indication of a determined weight for a second resource unit, where the first and second resource units being spaced apart at least in frequency. The feedback information further comprises at least one second indication, specified with Y bits where Y<X, of weights for each of a plurality of resource units intermediate the first and second resource units. The apparatus further includes a unit configurable to determine a weight for each of the plurality of intermediate resource units, where the at least one second indication specifies for use the indication of the determined weight of either the first resource unit or the second resource unit.

In a further aspect thereof the exemplary embodiments of this invention provide an apparatus that comprises means for accurately determining a weight for each of a first resource unit and a second resource unit that are spaced apart at least in frequency and for determining a weight for at least some of a plurality of resource units that are intermediate at least in frequency to the first and the second resource units. The apparatus further comprises means for transmitting an indication of the accurately determined weight for the first and the second resource units using Xbits for representing each of the indications of the determined weights, and also transmitting an indication of weights for each of the plurality of resource units using Ybits, where Y<X, and where the indication of the weights for each of the plurality of resource units specifies for use the transmitted indication of the determined weight of either the first resource unit or the second resource unit.

In a still further aspect thereof the exemplary embodiments of this invention provide an apparatus that comprises means for transmitting a plurality of resource units; means for receiving resource unit-related feedback information comprised of first indications, each specified with X bits, of a determined accurate weight for a first resource unit and an indication of a determined accurate weight for a second resource unit. The first and second resource units are spaced apart at least in frequency and the feedback information further comprises at least one second indication, specified with Y bits where Y′<X, of weights for each of a plurality of resource units intermediate the first and second resource units. The apparatus further includes means for determining a weight for each of the plurality of intermediate resource units, where the at least one second indication specifies for use the indication of the determined weight of either the first resource unit or the second resource unit.

### BRIEF DESCRIPTION OF THE DRAWINGS

In the attached Drawing Figures:

FIG. 1 depicts a first method for calculating weights and determining feedback for intermediate RBs, in accordance with a first exemplary embodiment of this invention.

FIG. 2 depicts a second method for calculating weights and determining feedback for intermediate RBs, in accordance with a second exemplary embodiment of this invention.

FIG. 3 depicts a third, multi-dimensional method for calculating weights and determining feedback for intermediate RBs, in accordance with a third exemplary embodiment of this invention.

FIG. 4 depicts a fourth, multi-dimensional method for calculating weights and determining feedback for intermediate RBs, in accordance with a fourth exemplary embodiment of this invention.

FIG. 5 is a block diagram of a MIMO-OFDM system in which the exemplary embodiments of this invention may be implemented.

FIG. 6 is a logic flow diagram that is illustrative of the exemplary embodiments of this invention.

FIG. 7 is another logic flow diagram that is illustrative of the exemplary embodiments of this invention.

FIG. 8 is another logic flow diagram that is illustrative of the exemplary embodiments of this invention.

FIG. 9 is another logic flow diagram that is illustrative of the exemplary embodiments of this invention:

### DETAILED DESCRIPTION

The exemplary embodiments of this invention are useful when providing a feedback method for a beamforming or precoding system, such as an OFDM-based beamforming or precoding system for single stream transmission or multi stream transmission.

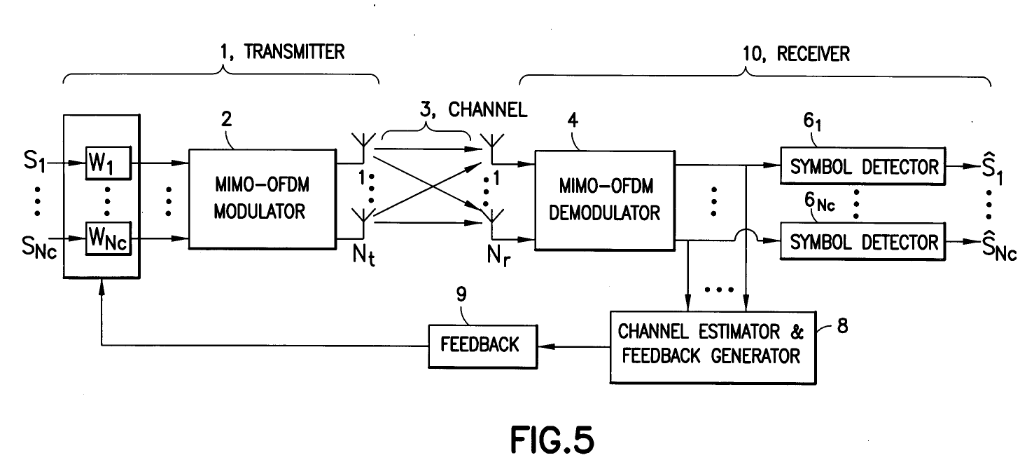

FIG. 5 shows a generalized architectural model of a MIMO-OFDM system within which the exemplary embodiments of this invention may be employed, and assumes a multi-antenna wireless communication system with Nₜ transmit antennas and Nᵣ receive antennas where OFDM that utilizes N_{c} sub-carriers is employed per antenna transmission. At a transmitter 1, such as a BS, one may assume the presence of information symbols s₁, s₂, . . . , s_{Nc}, which are modified by a Nₜ×1 precoding weight vector expressed as w₁, w₂, . . . , w_{Nc} and applied to a MIMO-OFDM modulator 2 for transmission through a channel 3 by the Nₜ transmit antennas. The transmitted signals are received at a receiver 10, such as a UE, by the Nᵣ receive antennas and are applied to a MIMO-OFDM demodulator 4. The outputs of the MIMO-OFDM demodulator 4 are applied to symbol detectors 6₁, 6₂, . . . , 6_{Nc} to recover, ideally, the input information symbols s₁, s₂, . . . , s_{Nc}. At the output of the MIMO-OFDM demodulator 4 is a channel estimator and feedback generator 8 that generates a feedback signal 9 to the transmitter 1. Based on the feedback 9, the transmitter 1 seeks to match the precoding vector (expressed as weights w₁, w₂, w_{Nc}) to the channel 3 to improve the system performance. For a multi stream transmission, s₁, s₂, . . . , s_{Nc} are all vectors of dimension Nₛ×1 and w₁, w₂, . . . , w_{Nc} are all matrices of Nₜ×Nₛ, where Nₛ is the number of data streams.

In general, the various embodiments of the receiver 10 can include, but are not limited to, user equipment such as cellular phones, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, as well as portable units or terminals that incorporate combinations of such functions. The transmitter 1 may be embodied in a base station.

In other embodiments of the invention the transmitter 1 may be the UE, and the receiver 10 may be the BS.

The exemplary embodiments of this invention may be implemented by computer software executable by a data processor of the receiver 10 and the other DPs, or by hardware, or by a combination of software and hardware.

The exemplary embodiments of this invention pertain at least in part to the operation of the channel estimator and feedback generator 8 in generating enhanced (and reduced overhead) feedback information, as well as to the operation of the transmitter 1 in interpreting and responding to the received feedback information.

It can be appreciated that channel gains at neighboring frequencies/intervals are similar and/or correlated so that the precoding weights for these frequencies/RBs should be similar or correlated to one another. In the exemplary embodiments of this invention, an accurate weight with FP is fed back for more than one of the RBs, where these FP RBs are spaced apart in frequency. The selection of precoding weights from a codebook typically follows selected criteria, such as maximizing post-processing signal-to-interference/noise ratio (SINR), maximizing the received total signal power, or maximizing the sum throughput of all streams, as non-limiting examples. Then relative feedback is used for intermediate RBs, i.e., those RBs for which an accurate weight is not fed back to the transmitter 1 during a particular feedback event. In the exemplary embodiments of this invention the relative weight does not constitute a tracking codebook with a set of nearest neighbors to a present feedback weight, as in the proposal that was discussed above. Instead, for each intermediate RB, the weights of the nearest two most accurate feedback weight RBs are considered, and the relative weight is determined by selecting between these two possible (accurate) weights according to selected criteria.

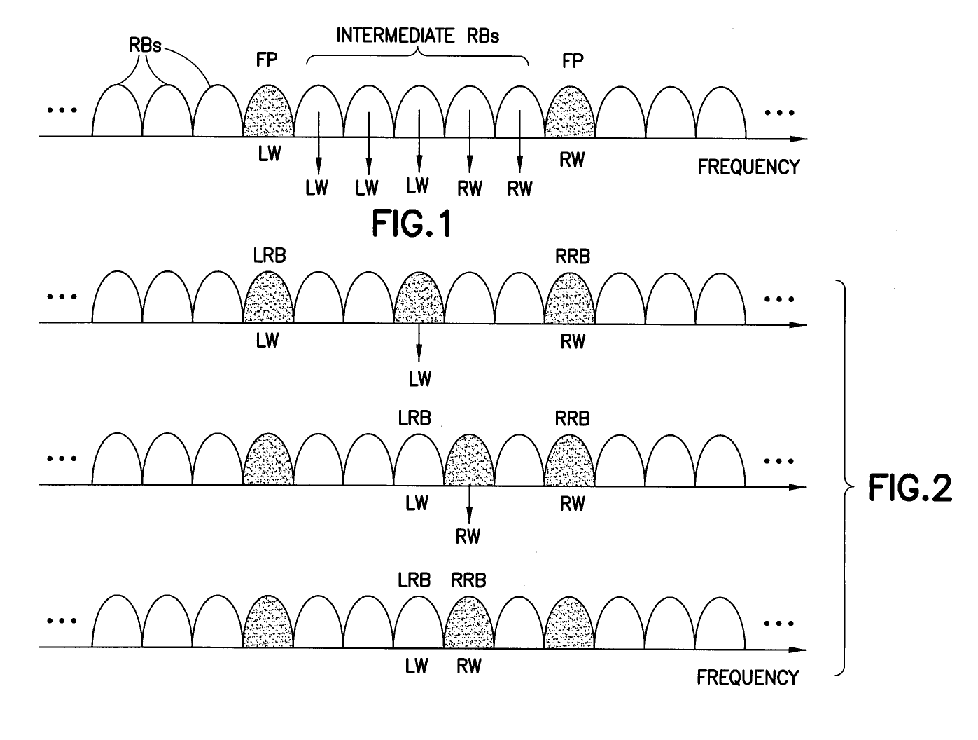

In operation, the precoding weights for certain RBs are calculated and quantized with FP to some number bits (e.g., three bits) which can be signaled in the UL. In FIG. 1, these RBs are designated as FP RBs and their weights are denoted as Left Weight (LW) and Right Weight (RW), respectively. As can be appreciated, for the intermediate RBs between the two FP RBs the weight search can be narrowed considerably. Due to the assumed channel correlation in frequency, the intermediate RB weight can be selected as one of the two weights of the two FP RBs, which has been calculated and quantized. In the illustrated example the three RBs would each be assigned the weight of the left-most FP RB, i.e. LW, and the two RBs would each be assigned the weight of the right-most FP RB, i.e. RW. In this case, only one feedback bit is needed for each RB to indicate whether LW or RW is selected, and the number of feedback bits for MRBs between two FP RBs is thus M. For a wideband OFDM system, the use of this technique significantly reduces the feedback overhead. In a case where the two FP RBs use the same weight value, then there is no need to feedback the M bits corresponding to the intermediate RBs between them, thereby even further reducing the feedback overhead.

To even further reduce the number of feedback bits, an enhanced method is provided as shown in FIG. 2. In this second, enhanced method, an accurate weight with full precision is fed back for more than one of the RBs, where these FP RBs are spaced apart in frequency. The selection of precoding weights from a codebook typically follows selected criteria, such as maximizing post-processing signal-to-interference/noise ratio (SINR), maximizing the received total signal power, or maximizing the sum throughput of all streams, as non-limiting examples. Then the weight to be fed back for intermediate RBs between two FP RBs is also based on selecting the weight from weights for FP feedback RBs. In order to further reduce the number of feedback bits, the second, enhanced method does not feed back the bits for each intermediate RB between two FP RBs. Instead, the method first sets a left resource block (LRB) and a right resource block (RRB) to the initial left RB with full precision and the initial right RB with full precision, respectively, and also sets a LW and a RW to the weight values of the LRB and RRB, respectively. The method then selects a weight from LW or RW for the RB which is located at the midpoint between LRB and RRB according to selected criteria. Then, if the weight selected is LW, the method sets LRB to that RB, and vice versa, as shown in the second line of FIG. 2. This process is continued until LRB and RRB are adjacent, as shown in the third line of FIG. 2. A switching point from LW to RW is thus obtained, which denotes the first intermediate RB that uses the same weight as the initial RRB with full precision (or the last intermediate RB that uses the same weight as the initial LRB with FP). In this case it is only necessary to feedback a sufficient number of bits to index the switching point.

One can see that the number of feedback bits for M RBs between two RBs with full precision is equal to the minimum positive integer which is not less than log₂(M+1), which leads to large reduction of feedback overhead. In the case that two RBs with full precision use the same weight, there is no need to feedback bits for all RBs between them, although in some implementations it may be simpler to always feedback the bits for all of the RBs. On the other hand, this second enhanced method also reduces the complexity to calculate the possible weights since not all the RBs are needed to calculate the weights.

Note that the foregoing exemplary embodiments of this invention do not require that the RBs at the edges of the bandwidth (or at the edges of a reporting bandwidth of the receiver 10, if the reporting bandwidth of the receiver 10 is less than the full system bandwidth) are RBs with accurate feedback (i.e., FP RBs). In one non-limiting embodiment those RBs that are, for example, to the left of the leftmost FP RB always use the same weight as the leftmost FP RB, and in this case no feedback is required for these RBs. In another non-limiting embodiment one bit is used to indicate whether the nearest (left most FP RB) or the next nearest (next to the left most FP RB) weight is used.

In the above and following descriptions, operations such as weight selection, weight feedback at the receiver and precoding at the transmitter, as non-limiting examples, can be tailored either for single stream transmission or for multi stream transmission, without changing the scope of the non-limiting and exemplary embodiments of this invention.

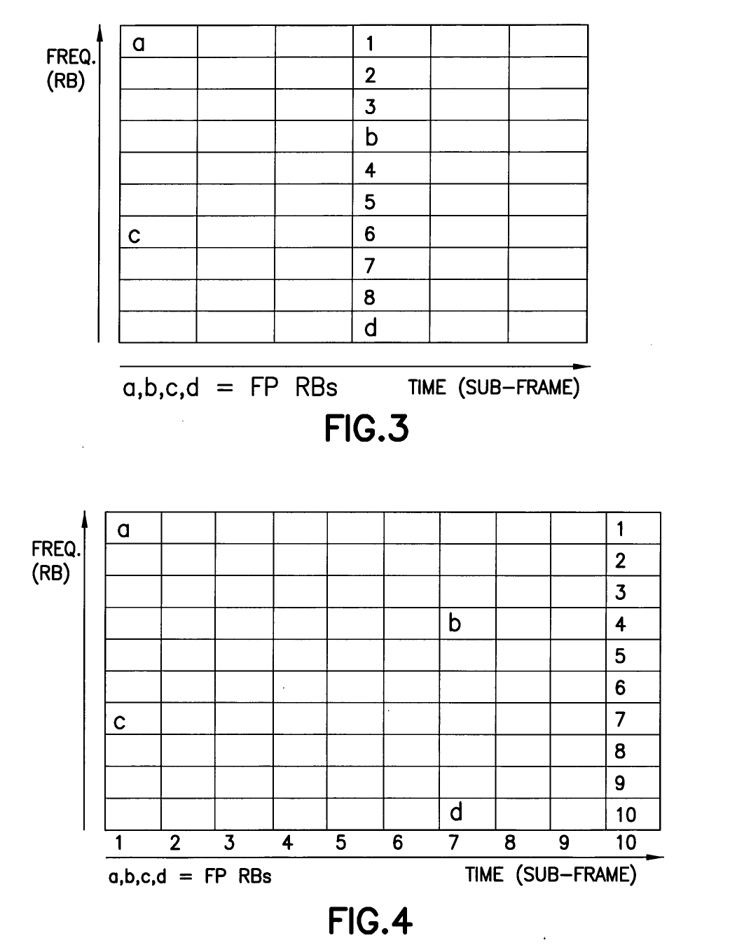

In the above description the RB is used to denote the resource unit in frequency (and time). However, the size of an RB can be flexible and in some systems it is also called a chunk. Therefore, the methods can also be used subcarrier-wise. Although the methods are described above specifically for the frequency domain, they may also be applied to the time domain as will be described below in relation to FIGS. 3 and 4.

Even more specifically, the RB or chunk denotes a minimum resource unit in frequency (and time) that is established for the feedback of precoding information (e.g., index of weight/weights). In a specific case of the LTE (evolved UTRAN) system, and possibly other systems as well, a minimum resource unit for feedback of precoding information can be two or more RBs/chunks. As such, it can be appreciated that the exemplary embodiments of this invention are flexible in the choice of this minimum resource unit that is used for the feedback of precoding information. Further, it should be appreciated that the foregoing and the following references to a resource block (RB) should be broadly interpreted as referring to this minimum “resource unit” used for feedback purposes.

The exemplary embodiments of this invention discussed above may be generalized to operate in more than one (e.g., frequency) dimension. For example, a two dimensional time-frequency generalization can be employed as shown in FIG. 3. In this embodiment feedback is transmitted with a specified interval of every (for example) third sub-frame. In FIG. 3 new feedback information is available in the first and fourth sub-frames. In other embodiments the feedback could be transmitted in every sub-frame, or in every second sub-frame, or in every fourth sub-frame, and so forth. The RBs with accurate FB (i.e., FP FB, labeled a, b, c and d) may change from one FB transmission to next. It can be appreciated that the identities of the reported FP RBs per sub-frame reporting period are known a priori by the receiver and transmitter, or some additional signaling is utilized to identify to the transmitter which RBs are being reported with FP. Such signaling may be predefined by a specification or standard, for example. Thus, in the illustrated non-limiting example during the first feedback transmission, which is available during the transmission of the first sub-frame, the FP RB FB corresponds to the RBs labeled a and c, while in the second feedback transmission, available during the fourth sub-frame, the FP RB FB corresponds to the RBs labeled b and d. There may be a general assumption of the correlation in the time domain, versus the correlation in the frequency domain, based on an agreement between the transmitter and the receiver, and may be predefined by a specification or standard. Alternatively, the entity calculating the feedback (e.g., the channel estimator and feedback generator 8 of FIG. 5), may estimate the correlations in the frequency and time domain, adapt the relative weight to this estimate, and feed the estimate back together with the relative RB feedback.

In an embodiment that generalizes the first method discussed above with respect to FIG. 1 there may be, for example, fed back one relative feedback bit for each of the intermediate RBs in those sub-frames where feedback is updated (e.g., the RBs 1, 2, 3, 4, 5, 6, 7 and 8 in the fourth sub-frame shown in FIG. 3). The relative strengths of frequency and time correlation may be fed back using one bit for the full feedback word. Two alternatives may be:

(i) the older more accurate feedback is discarded altogether, and the relative bits operate in the frequency domain as indicated above in the method shown in FIG. 1; or
(ii) the previous more accurate feedback is considered to have a higher correlation to the RBs that are closer to it in the frequency domain than the further of the two accurate FP weights of the most recent feedback. Thus, in FIG. 3 for the intermediate RBs numbered 1, 2 and 3, the relative feedback bit would indicate whether FP weight a orb is closer, for those RBs numbered 4 and 5 the relative bit would indicate whether FP weight b or c is closer, and for intermediate RBs labeled 6, 7 and 8 whether FP weight c or d is closer.

In this example, it may be decided by previous agreement whether in alternative (ii), and for example, the RB 6 is indicated as being between FP weights b and c or between FP weights c and d.

The second method discussed above with regard to FIG. 2 may be generalized in a similar way, and there can be two alternatives considered:

(i) the older feedback is discarded, and weights are calculated as discussed above, in relation to FIG. 2; or
(ii) the previous feedback is taken into account. In this case the FB bits indicate the switching point between a and b as one of RBs 1-3, switching between b and c as one of RBs 4-5, and switching between c and d as one of RBs 6-8.

To maintain the number of bits constant between the cases where the older feedback is taken and not taken into account, one may reduce the number of signaling options in the case that the older feedback is taken into account. For example, case ii with the second method may be such that weight c is always used for RB 6, and the switching between b and c is indicated as one of RBs 4-5, and switching between weights c and d as one of RBs 7-8. The number of bits needed for these alternatives depends on the distance between those RBs with accurate feedback (i.e., on the number of RBs between the FP RBs).

Further optimization of feedback usage may be achieved by increasing the interval between transmitting the FP RB feedback. Thus, in FIG. 4 the interval of accurate feedback transmission is increased to six sub-frames (as an example). In the middle of the accurate FB transmission interval (e.g., sub-frames 4 and 10 in this exemplary case) only relative weights are fed back, and with one bit one may select whether the relative weight takes the older feedback into account or not. As an example, weight feedback for RBs 1-10 in the tenth sub-frame (i.e., the last sub-frame shown) is considered herewith. If the additional FB bit is zero, the relative FB used in the last sub-frame would only take into account the accurate FB sent in the seventh sub-frame, that is, the accurate FB in FP RBs b and d. If the bit is instead a one, the relative FB used in the last sub-frame takes into account the accurate FB sent in the first and the seventh sub-frames. For the RBs numbered 1-3, the relative weight would select between a and b. For RB 4, one may either assume directly weight b, or a relative weight between b and, for example, a or c, and so forth.

Note that these generalizations in time domain as shown in FIGS. 3 and 4 may be extended to take into account any number of previous feedback events. In the above description, the sub-frame is used to denote the resource unit in time. However, the size of a resource unit in time can be flexible. Therefore, the methods can also be used for any resource unit in time, such as an OFDM symbol, a frame, a time slot or a TTI, as non-limiting examples.

Based on the foregoing it should be apparent that the exemplary embodiments of this invention provide a method, apparatus and computer program product(s) to provide reduced overhead feedback to a transmitter that can be used for determining a plurality of transmitter weights in an OFDM system.

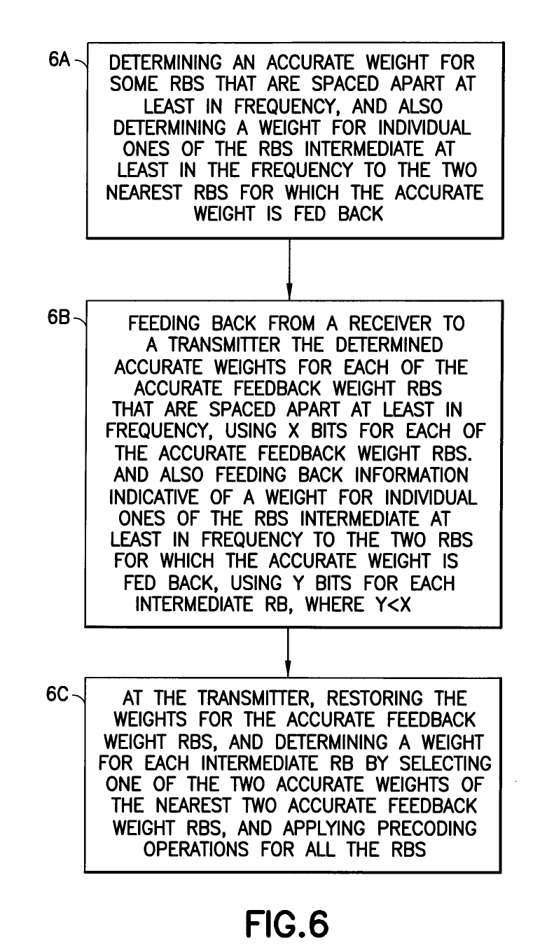

In accordance with a first method of this invention, and referring to FIG. 6, the first method comprises determining an accurate weight for some RBs that are spaced apart at least in frequency, and also determining a weight for individual ones of the RBs intermediate at least in frequency to the two nearest RBs for which the accurate weight is fed back (Step 6A); feeding back from a receiver to a transmitter the determined accurate weights for each of the accurate feedback weight RBs that are spaced apart at least in frequency, using X bits for each of the accurate feedback weight RBs, and also feeding back information indicative of a weight for individual ones of the RBs intermediate at least in frequency to the two RBs for which the accurate weight is fed back, using Y bits for each intermediate RB, where Y<X (Step 6B). At the transmitter the method comprises restoring the weights for the accurate feedback weight RBs, and determining a weight for each intermediate RB by selecting one of the two accurate weights of the nearest two accurate feedback weight RBs, and applying precoding operations for all the RBs (Step 6C).

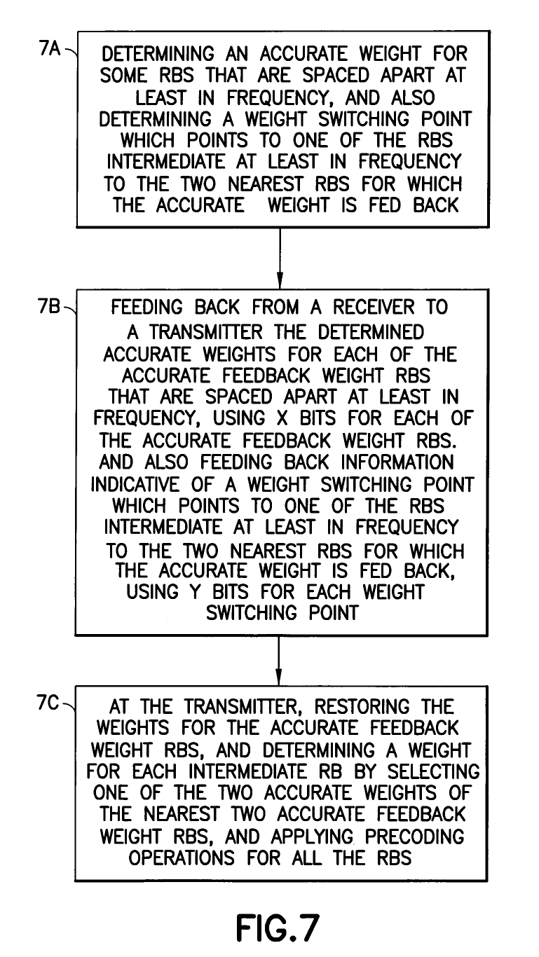

In accordance with a second method of this invention, and referring to FIG. 7, a second method comprises determining an accurate weight for some RBs that are spaced apart at least in frequency, and also determining a weight switching point which points to one of the RBs intermediate at least in frequency to the two nearest RBs for which the accurate weight is fed back (Step 7A); feeding back from a receiver to a transmitter the determined accurate weights for each of the accurate feedback weight RBs that are spaced apart at least in frequency, using X bits for each of the accurate feedback weight RBs, and also feeding back information indicative of a weight switching point which points to one of the RBs intermediate at least in frequency to the two nearest RBs for which the accurate weight is fed back, using Y bits for each weight switching point (Step 7B). At the transmitter the method comprises restoring the weights for the accurate feedback weight RBs, and determining a weight for each intermediate RB by selecting one of the two accurate weights of the nearest two accurate feedback weight RBs, and applying precoding operations for all the RBs (Step 7C).

Non-limiting examples of additional embodiments for this invention include:

(a) The two methods as in the previous paragraphs, where the two RBs for which the accurate weights are determined are spaced apart in frequency in one transmitted sub-frame.

(b) The two methods as in the previous paragraphs, where the two RBs for which the accurate weights are determined are also spaced apart in time, such as being located in adjacent or non-adjacent transmitted sub-frames.

(c) The two methods as in the previous paragraphs where, when the two RBs are also spaced apart in time, different RBs may be selected for determining the accurate weight from one sub-frame to the next during which a feedback event occurs.

The two methods as in the previous paragraphs where, when the two RBs are also spaced apart in time, the bit of individual RBs may indicate whether the accurate weights from a previous sub-frame are considered or not considered when determining a weight for some intermediate RBs.

The first method as in the foregoing paragraphs where Y equals one if the determined accurate weights for two RBs are not equal.

The second method as in the foregoing paragraphs where Y equals the minimum positive integer which is not less than log₂(M+1), if the determined accurate weights for two RBs are not equal and the number of RBs intermediate to the two nearest RBs is M+1.

The two methods as in the foregoing paragraphs where Y equals zero if the determined accurate weights for two RBs are equal.

In accordance with a computer program product that is another exemplary embodiment of this invention, execution of computer program instructions results in operations that comprise determining an accurate weight for some RBs that are spaced apart at least in frequency, determining a weight for individual ones of the RBs intermediate at least in frequency to the two nearest RBs for which the accurate weight is fed back, feeding back from a receiver to a transmitter the determined accurate weights for each of the accurate feedback weight RBs that are spaced apart at least in frequency, using X bits for each of the accurate feedback weight RBs, and also feeding back information indicative of a weight for individual ones of the RBs intermediate at least in frequency to the two RBs for which the accurate weight is fed back, using Y bits for each intermediate RB, where Y<X. At the transmitter, the weights for the accurate feedback weight RBs are restored, a weight for each intermediate RB is determined by selecting one of the two accurate weights of the nearest two accurate feedback weight RBs, and precoding operations are applied for all the RBs. The two RBs for which the accurate weight is determined may be spaced apart in frequency in one transmitted sub-frame, and may be also spaced apart in time, such as being in adjacent or in non-adjacent transmitted sub-frames. When the two RBs are also spaced apart in time, different RBs may be selected for determining the accurate weight from one sub-frame to the next during which a feedback events occur. Y may equal one.

In accordance with another computer program product that is another exemplary embodiment of this invention, execution of computer program instructions results in operations that comprise determining an accurate weight for some RBs that are spaced apart at least in frequency, determining a weight switching point which points to one of the RBs intermediate at least in frequency to the two nearest RBs for which the accurate weight is fed back, feeding back from a receiver to a transmitter the determined accurate weights for each of the accurate feedback weight RBs that are spaced apart at least in frequency, using X bits for each of the accurate feedback weight RBs, and also feeding back information indicative of a weight switching point which points to one of the RBs intermediate at least in frequency to the two nearest RBs for which the accurate weight is fed back, using Y bits for each weight switching point. At the transmitter, the weights for the accurate feedback weight RBs are restored, a weight for each intermediate RB is determined by selecting one of the two accurate weights of the nearest two accurate feedback weight RBs, and precoding operations are applied for all the RBs. The two RBs for which the accurate weight is determined may be spaced apart in frequency in one transmitted sub-frame, and may be also spaced apart in time, such as being in adjacent or in non-adjacent transmitted sub-frames. When the two RBs are also spaced apart in time, different RBs may be selected for determining the accurate weight from one sub-frame to the next during which a feedback event occurs. Y may equal the minimum positive integer which is not less than log₂(M+1), where the number of RBs intermediate to the two nearest RBs is M+1.

In accordance with an apparatus that is another exemplary embodiment of this invention, a receiver includes a unit adapted to determine an accurate weight for two RBs that are spaced apart at least in frequency, and to determine a weight for individual ones of the RBs intermediate at least in frequency to the two nearest RBs for which the accurate weight is fed back, and to feed back to a transmitter the determined accurate weights, using X bits for each of the two RBs that are spaced apart at least in frequency, and to feed back using Y bits information indicative of a weight for individual ones of the RBs intermediate at least in frequency to the two RBs for which the accurate weight is fed back, where Y<X. At the transmitter, a unit is adapted to restore the weights for the accurate feedback weight RBs, and to determine a weight for each intermediate RB by selecting one of the two accurate weights of the nearest two accurate feedback weight RBs, and to apply precoding operations for all the RBs. The two RBs for which the accurate weight is determined may be spaced apart in frequency in one transmitted sub-frame, and may be also spaced apart in time, such as being in adjacent or in non-adjacent transmitted sub-frames. When the two RBs are also spaced apart in time, different RBs may be selected for determining the accurate weight from one sub-frame to the next during which a feedback events occur. Y may equal one. The apparatus may be embodied in whole or in part in an integrated circuit.

In accordance with another apparatus that is another exemplary embodiment of this invention, a receiver includes a unit adapted to determine an accurate weight for two RBs that are spaced apart at least in frequency, and to determine a weight switching point which points to one of the RBs intermediate at least in frequency to the two nearest RBs for which the accurate weight is fed back, and to feed back to a transmitter the determined accurate weights, using X bits for each of the two RBs that are spaced apart at least in frequency, and to feed back using Y bits information indicative of a weight switching point which points to one of the RBs intermediate at least in frequency to the two nearest RBs for which the accurate weight is fed back. At the transmitter, a unit is adapted to restore the weights for the accurate feedback weight RBs, and to determine a weight for each intermediate RB by selecting one of the two accurate weights of the nearest two accurate feedback weight RBs, and to apply precoding operations for all the RBs. The two RBs for which the accurate weight is determined may be spaced apart in frequency in one transmitted sub-frame, and may be also spaced apart in time, such as being in adjacent or in non-adjacent transmitted sub-frames. When the two RBs are also spaced apart in time, different RBs may be selected for determining the accurate weight from one sub-frame to the next during which a feedback events occur. Y may equal one. The apparatus may be embodied in whole or in part in an integrated circuit.

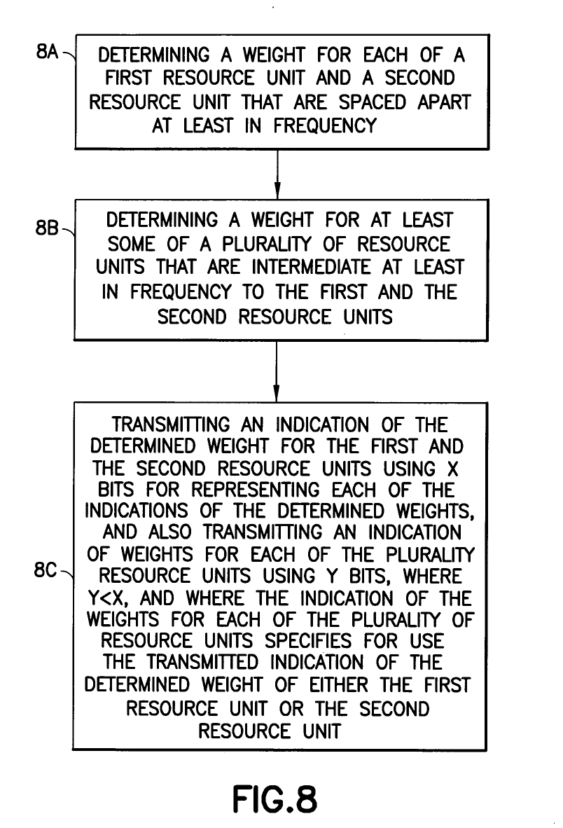

FIG. 8 is another logic flow diagram that is illustrative of the exemplary embodiments of this invention. FIG. 8 shows a method that includes (Block 8A) determining a weight for each of a first resource unit and a second resource unit that are spaced apart at least in frequency; (Block 8B) determining a weight for at least some of a plurality of resource units that are intermediate at least in frequency to the first and the second resource units; and (Block 8C) transmitting an indication of the determined weight for the first and the second resource units using X bits for representing each of the indications of the determined weights, and also transmitting an indication of weights for each of the plurality of resource units using Y bits, where Y<X, and where the indication of the weights for each of the plurality of resource units specifies for use the transmitted indication of the determined weight of either the first resource unit or the second resource unit.

In the foregoing method the resource units may each comprise at least one frequency sub-carrier that are transmitted during sub-frames, the first resource unit and the second resource unit in a first sub-frame may differ from the first resource unit and the second resource unit in a second sub-frame, and the indication of weights for each of the plurality of resource units may specify for use the transmitted indication of the determined weight of either the first resource unit or the second resource unit in a current sub-frame, or the transmitted indication of the determined weight of either the first resource unit or the second resource unit in a previous sub-frame.

The foregoing method may be performed as a result of execution of computer program instructions that are stored in a memory medium that comprises part of a user equipment 10 that receives resource units from the transmitter 1, where transmitting the indication of the determined weight for the first and the second resource units and the indication of weights for each of the plurality of resource units comprises transmitting feedback information to the transmitter.

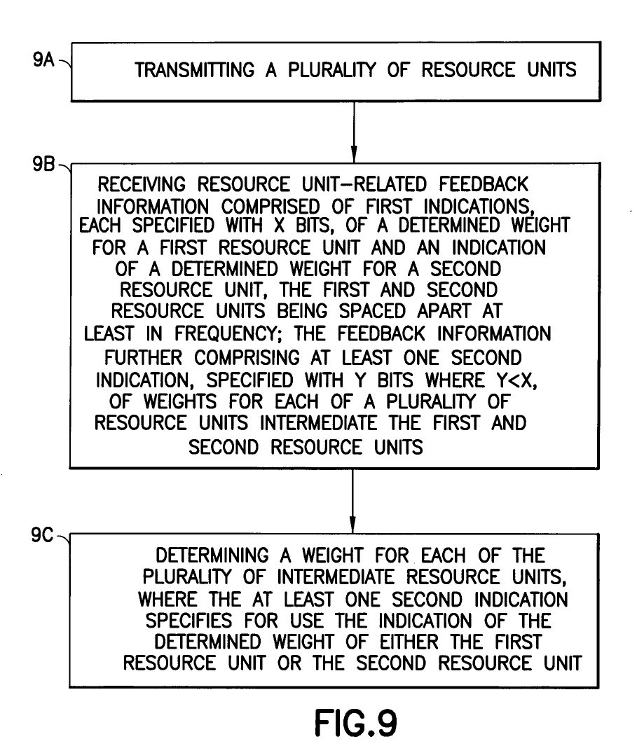

FIG. 9 is another logic flow diagram that is illustrative of the exemplary embodiments of this invention. FIG. 9 shows a method that includes (Block 9A) transmitting a plurality of resource units; (Block 9B) receiving resource unit-related feedback information comprised of first indications, each specified with X bits, of a determined weight for a first resource unit and an indication of a determined weight for a second resource unit, the first and second resource units being spaced apart at least in frequency; the feedback information further comprising at least one second indication, specified with Y bits where Y<X, of weights for each of a plurality of resource units intermediate the first and second resource units; and (Block 9C) determining a weight for each of the plurality of intermediate resource units, where the at least one second indication specifies for use the indication of the determined weight of either the first resource unit or the second resource unit.

The foregoing method may also be performed as a result of execution of computer program instructions that are stored in a memory medium.

In general, the various exemplary embodiments described above may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the exemplary embodiments of this invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

As such, it should be appreciated that at least some aspects of the exemplary embodiments of the inventions may be practiced in various components such as integrated circuit chips and modules. The design of integrated circuits is by and large a highly automated process. Complex and powerful software tools are available for converting a logic level design into a semiconductor circuit design ready to be fabricated on a semiconductor substrate. Such software tools can automatically route conductors and locate components on a semiconductor substrate using well established rules of design, as well as libraries of pre-stored design modules. Once the design for a semiconductor circuit has been completed, the resultant design, in a standardized electronic format (e.g., Opus, GDSII, or the like) may be transmitted to a semiconductor fabrication facility for fabrication as one or more integrated circuit devices.

It should be noted that the terms “connected,” “coupled,” or any variant thereof, mean any connection or coupling, either direct or indirect, between two or more elements, and may encompass the presence of one or more intermediate elements between two elements that are “connected” or “coupled” together. The coupling or connection between the elements can be physical, logical, or a combination thereof. As employed herein two elements may be considered to be “connected” or “coupled” together by the use of one or more wires, cables and/or printed electrical connections, as well as by the use of electromagnetic energy, such as electromagnetic energy having wavelengths in the radio frequency region, the microwave region and the optical (both visible and invisible) region, as several non-limiting and non-exhaustive examples.

Various modifications and adaptations to the foregoing exemplary embodiments of this invention may become apparent to those skilled in the relevant arts in view of the foregoing description, when read in conjunction with the accompanying drawings. However, any and all modifications will still fall within the scope of the non-limiting and exemplary embodiments of this invention.

Further, it should be appreciated that references to “left” and to “right” weights and RBs are merely for descriptive purposes, and are not to be construed in a limiting sense.

Furthermore, some of the features of the various non-limiting and exemplary embodiments of this invention may be used without the corresponding use of other features. As such, the foregoing description should be considered as merely illustrative of the principles, teachings and exemplary embodiments of this invention, and not in limitation thereof.

1. A method, comprising:
determining a weight for each of a first resource unit and a second resource unit that are spaced apart at least in frequency;
determining a weight for at least one of a plurality of resource units that are intermediate at least in frequency to the first and the second resource units; and
transmitting an indication of the determined weight for the first and the second resource units using X bits for representing each of the indications of the determined weights, and also transmitting an indication of weights for at least one of the plurality of resource units using Y bits, wherein Y<X, and wherein the indication of the weights for at least one of the plurality of resource units specifies for use the transmitted indication of the determined weight of at least one of the first resource unit ef and the second resource unit.

2-45. (canceled)

46. The method according to claim 1, wherein M resource units of said plurality of resource units are intermediate at least in frequency to the first and the second resource units, wherein M is greater than one, and wherein Y=M for indicating the weight for each individual one of the plurality of resource units that are intermediate at least in frequency to the first and the second resource units.

47. The method according to claim 1, wherein M resource units of said plurality of resource units are intermediate at least in frequency to the first and the second resource units, wherein M is greater than one, and wherein Y is equal to a minimum positive integer which is not less than log₂(M+1) for indicating a particular one of the resource units that is intermediate at least in frequency to the first and the second resource units.

48. The method according to in claim 1, executed in a multiple input/multiple output wireless communication system, wherein the weights comprise precoding weights.

49. The method according to claim 1, further comprising not transmitting the indication of weights for each of the plurality of resource units when the determined weights for the first and the second resource units are substantially equal.

50. The method according to claim 1, the method being performed by a user equipment that receives resource units from a transmitter, wherein transmitting the indication of the determined weight for the first and the second resource units and the indication of weights for at least one of the plurality of resource units comprises transmitting feedback information to the transmitter.

51. The method according to claim 1, performed as a result of execution of computer program instructions that are stored in a memory medium that comprises part of a user equipment that receives resource units from a transmitter, wherein transmitting the indication of the determined weight for the first and the second resource units and the indication of weights for at least one of the plurality of resource units comprises transmitting feedback information to the transmitter.

52. An apparatus, comprising:
a channel estimator and feedback generator configurable to determine a weight for each of a first resource unit and a second resource unit that spaced apart at least in frequency, to determine a weight for at least one of a plurality of resource units that are intermediate at least in frequency to the first and the second resource units and to send feedback, wherein the feedback comprising an indication of the determined weight for the first and the second resource units using X bits for representing each of the indications of the determined weights, and further comprising an indication of weights for at least one of the plurality of resource units using Y bits, wherein Y<X, wherein the indication of the weights for at least one of the plurality of resource units specifies for use the transmitted indication of the determined weight of at least one of the first resource unit and the second resource unit.

53. The apparatus according to claim 52, wherein M resource units of said plurality of resource units are intermediate at least in frequency to the first and the second resource units, wherein M is greater than one, and wherein Y=M for indicating the weight for each individual one of the plurality of resource units that are intermediate at least in frequency to the first and the second resource units.

54. The apparatus according to claim 52, wherein M resource units of said plurality of resource units are intermediate at least in frequency to the first and the second resource units, wherein M is greater than one, and wherein Y is equal to a minimum positive integer which is not less than log₂(M+1) for indicating a particular one of the resource units that is intermediate at least in frequency to the first and the second resource units.

55. The apparatus according to claim 52, comprising a user equipment configurable for operation in a multiple input/multiple output wireless communication system, wherein the weights comprise precoding weights.

56. The apparatus according to claim 52, wherein for a case that the determined weights for the first and the second resource units are substantially equal, said channel estimator and feedback generator does not send the indication of weights for each of the plurality of resource units.

57. The apparatus according to claim 52, wherein said channel estimator and feedback generator is embodied in an at least one integrated circuit.

58. A method, comprising:
receiving resource unit-related feedback information comprising first indications, each specified with X bits, of a determined weight for a first resource unit and an indication of a determined weight for a second resource unit, the first and second resource units being spaced apart at least in frequency; the feedback information further comprising at least one second indication, specified with Y bits wherein Y<X, of weights for at least one of a plurality of resource units intermediate the first and second resource units; and
determining a weight for at least one of the plurality of intermediate resource units, wherein the at least one second indication specifies for use the indication of the determined weight of at least one of the first resource unit and the second resource unit.

59. The method according to claim 58, wherein M resource units of said plurality of resource units are intermediate at least in frequency to the first and the second resource units, wherein M is greater than one, wherein in one case Y=M for indicating the weight for each individual one of the plurality of resource units that are intermediate at least in frequency to the first and the second resource units, and in another case Y is equal to a minimum positive integer which is not less than log₂(M+1) for indicating a particular one of the resource units that is intermediate at least in frequency to the first and the second resource units.

60. The method according to claim 58, executed in a multiple input/multiple output wireless communication system, wherein the weights comprise precoding weights.

61. The method according to claim 58, performed as a result of execution of computer program instructions that are stored in a memory medium that comprises part of a base station that transmits the resource units to a user equipment.

62. An apparatus, comprising:
a wireless receiver configured to receive resource unit-related feedback information comprised of first indications, each specified with X bits, of a determined weight for a first resource unit and an indication of a determined weight for a second resource unit, the first and second resource units being spaced apart at least in frequency; the feedback information further comprising at least one second indication, specified with Y bits wherein Y<X, of weights for at least one of a plurality of resource units intermediate the first and second resource units; and
a unit configurable to determine a weight for at least one of the plurality of intermediate resource units, wherein the at least one second indication specifies for use the indication of the determined weight of at least one of the first resource unit and the second resource unit.

63. The apparatus according to claim 62, wherein M resource units of said plurality of resource units are intermediate at least in frequency to the first and the second resource units, wherein M is greater than one, wherein in one case Y=M for indicating the weight for each individual one of the plurality of resource units that are intermediate at least in frequency to the first and the second resource units, and in another case Y is equal to a minimum positive integer which is not less than log₂(M+1) for indicating a particular one of the resource units that is intermediate at least in frequency to the first and the second resource units.

64. The apparatus according to claim 62, executed in a multiple input/multiple output wireless communication system, wherein the weights comprise precoding weights.
